(19) United States
(12) Patent Application Publication
(10) Pub. No.: US 2007/0256401 A1
(43) Pub. Date: Nov. 8, 2007

(54) Drive operation device of walk-behind lawn mower

(76) Inventors: Yoshihisa Hibi, Toyokawa-City (JP); Graeme Sidney Parris, Toyokawa-City (JP); Akio Hayashi, Toyokawa-City (JP)

Correspondence Address: WENDEROTH, LIND & PONACK, L.L.P., 2033 K STREET N. W., SUITE 800, WASHINGTON, DC, 20006-1021, US

(21) Appl. No.: 11/790,208

(22) Filed: Apr. 24, 2007

(30) Foreign Application Priority Data
Apr. 27, 2006 (JP) 123341/2006

(51) Int. Cl. A01D 75/28

(52) U.S. Cl. 56/10.5

(57) ABSTRACT

A walk-behind lawn mower in a form that a handle arm is integrally provided toward an obliquely upper back in a rear of a machine, and a loop handle is provided at a rear end of the relevant handle arm with slightly tilting forward, and a driver performs drive operation while walking following the machine that travels by itself at a back of the machine, includes a throttle lever, the throttle lever being able to be drawn together with the handle by being operated by either of right and left hands grasping the handle, in addition, engine rotation frequency being able to be controlled using the amount of drawing, wherein the throttle lever is rotatably provided on the handle arm in an obliquely lower front or obliquely upper back of the handle.

### BACKGROUND OF THE INVENTION

1. Field of the Invention

The present invention relates to a drive operation device of a walk-behind lawn mower in which a loop handle is provided, and an operator performs drive operation while walking following a machine that travels by itself at a back of the machine.

2. Description of Related Art

In the walk-behind lawn mower in the above form (hereinafter, simply abbreviated as “lawn mower” in some cases), a handle arm is integrally provided toward an obliquely upper back in a rear of a machine, and a loop handle is provided at a rear end of the relevant handle arm with slightly tilting forward, and an operator performs drive operation while walking following the machine that travels by itself at a back of the machine with grasping respective standing portions at both sides of the handle with both hands.

In the lawn mower in the above form, a lawn mower is known, which is in a configuration where a clutch lever is provided near the loop handle, the lever being for on/off operation of transmission of engine power to a drum and a reel cutter unit, and the clutch lever is also operated by the hands grasping the handle. Moreover, a lawn mower is known, in which a safety lever for disabling clutch connection is provided behind the loop handle, and the safety lever is drawn to a handle side by the hands grasping the handle during normal operation, and when the operator cannot follow the machine due to an abnormal event, the safety lever is separated from the handle by a bias unit to disengage the clutch, thereby the machine is stopped for safety (JP-A-9-249044).

In a configuration of the lawn mowers, while any of them has an advantage that the clutch lever can be operated together with grasp of the handle by the hands grasping the handle, either of the hands grasping the handle is released to operate a throttle lever for controlling engine rotation frequency. Accordingly, there has been a difficulty that when the machine is turned, speed of the machine is temporarily reduced in a typical case, therefore the throttle lever is complicatedly operated in the above way, and since the throttle lever is provided at only one side in a lateral direction of the handle arm, when lawn is mowed with the machine being alternately turned in directions opposite to each other, the throttle lever is in a position far from an operator side in either turn, consequently the throttle lever is further hard to be operated.

### SUMMARY OF THE INVENTION

A subject of an embodiment of the invention is to facilitate drive operation of the walk-behind lawn mower by enabling operation of a throttle lever together with grasp of a loop handle by hands grasping the handle.

A first aspect of the invention to achieve the subject is a walk-behind lawn mower in a form that a handle arm is integrally provided toward an obliquely upper back in a rear of a machine, and a loop handle is provided at a rear end of the relevant handle arm with slightly tilting forward, and an operator performs drive operation while walking following the machine that travels by itself at a back of the machine, includes a throttle lever, the throttle lever being able to be drawn together with the handle by being operated by either of right and left hands grasping the handle, in addition, engine rotation frequency being able to be controlled using the amount of drawing, wherein the throttle lever is rotatably provided on the handle arm in an obliquely lower front or obliquely upper back of the handle.

In typical lawn mowing, an operator performs drive operation while walking following a machine in travelling with grasping standing portions of a loop handle with both hands. In the first aspect of the invention, since either of the hands grasping the handle can draw the throttle lever, the operator can draw the throttle lever with one or both of the hands grasping the handle, and can control the engine rotation frequency by controlling the amount of drawing. Accordingly, when an operator desires control of travel speed during lawn mowing, the operator can control the amount of drawing of the throttle lever in a posture while grasping the handle with hands without releasing the hands from the handle.

In particular, when the machine is turned, since the throttle lever can be drawn by either hand, the throttle lever is drawn by a necessary amount by one of hands grasping the handle, thereby the machine can be turned in the same drive operation posture except for difference in horizontal direction at optimum speed and in either of right and left directions. Accordingly, drive operation is facilitated when the machine is turned. The “loop handle” includes not only a handle having a perfectly closed form in a loop shape, but also a handle having a perfect loop form being partially lacked, and means a handle for performing drive with grasping a portion standing from the handle arm at high frequency.

A second aspect of the invention is characterized in that in the first aspect of the present invention, the throttle lever is provided in an obliquely lower front of the handle, and a clutch lever, which can be grasped together with the handle by either of right and left hands grasping the handle, is rotatably provided in an obliquely upper back of the handle, and three components of the handle, clutch lever, and throttle lever are grasped together for operation.

According to the second aspect of the invention, since drive operation can be performed with grasping the three components of the handle, clutch lever, and throttle lever together, control of engine rotation frequency, that is, control of travel speed of the machine, in addition, on/off operation of a clutch can be performed by a hand grasping the handle. Accordingly, since each operation of start and stop of travel of the machine can be performed by grasping the clutch lever by a hand grasping the handle, or simply releasing the clutch lever grasped together with the handle by the hand, not only control operation of travel speed of the machine by the throttle lever, but also each operation of start and stop of travel of the machine is facilitated. Moreover, since the throttle lever is provided in the obliquely lower front of the handle, travel speed of the machine can be controlled by lightly drawing or separating the lever with respect to the handle by fingertips of the hand grasping the handle, thereby travel speed of the machine can be controlled.

A third aspect of the invention is characterized in that in the second aspect of the present invention, the handle is in a shape in which both ends of a horizontal fixing portion fixed to the handle arm is inwardly bent at an angle of more than 90 degrees, thereby a horizontal pair of grasp portions being oppositely disposed are formed in a standing manner; the throttle lever is in an approximately T-shape, in which a horizontal rod portion is provided along a lateral direction of the machine in upper ends of rotation support rods rotatably supported in a condition standing from the handle arm; and both ends of the horizontal rods of the throttle lever are bent to an oblique lower side such that they are approximately parallel to the grasp portions in a condition of being disposed in an overlapped manner with the grasp portions along the lateral direction of the machine so that they are easily grasped by the hands grasping the grasp portions of the handle, thereby both the ends are formed as drawing portions.

According to the third aspect of the invention, since the grasp portions of the loop handle and the drawing portions of the throttle lever are disposed approximately parallel to each other in the overlapped manner along the lateral direction of the machine, the drawing portions of the throttle lever can be lightly drawn by fingertips of hands grasping the grasp portions of the handle. Therefore, particularly when the machine is turned, a condition that the throttle lever is drawn by an optimum amount by fingertips of one of the hands grasping the grasp portions of the handle can be kept, consequently drive operation is facilitated when the machine is turned.

A forth aspect of the invention is characterized in that in any one of the first to third aspects of the invention, the throttle lever is rotationally biased in a direction to be separated from the handle, and the throttle lever is drawn to a handle side to be close to the handle, thereby engine rotation frequency is increased, and the engine rotation frequency is minimized by releasing the throttle lever.

According to the forth aspect of the invention, when the throttle lever being drawn to the handle by hands grasping the handle is released, the throttle lever is maximally separated from the handle by rotation biasing force so that the engine rotation frequency is minimized, and the clutch is made to be off at the same time, thereby the machine is stopped. Accordingly, even if the throttle lever is not rotated in each case by a hand released from the handle unlike a usual machine, the machine can be momentarily stopped, or can start travelling, consequently drive operation associated with stop of the machine and start of travel is facilitated.

In this way, in an embodiment of the invention, since the throttle lever can be drawn by either of hands grasping the loop handle, an operator can draw the throttle lever by one or both of hand grasping the handle, and can control the engine rotation frequency by controlling the amount of drawing. Therefore, when travel speed is desired to be controlled during lawn mowing, the amount of drawing of the throttle lever can be controlled in a posture with the handle being grasped by hands without releasing hands from the handle, and when the machine is turned, since the throttle lever can be drawn by either of hands, the throttle lever is drawn by the necessary amount by one of hands grasping the handle, thereby the machine can be turned at optimum speed in the same drive operation posture except for difference in horizontal direction in a turn in either of right and left directions, consequently drive operation is facilitated when the machine is turned.

### BRIEF DESCRIPTION OF THE DRAWINGS

FIG. 1 is an overall perspective view of a walk-behind lawn mower according to an embodiment of the invention;

FIG. 2 is a plane view of the lawn mower in a condition that a grass catcher 6 is removed;

FIG. 3 is a side view of the lawn mower in a condition of lawn mowing;

FIG. 4 is an exploded perspective view of a handle H, throttle lever L₁, and clutch lever L₂, which are fixed to a handle arm A;

FIG. 5 is a perspective view, which is seen from a lower side, of only a portion of the throttle lever L₁ attached to the handle arm A;

FIG. 6 is a side view of a portion of the handle H in a condition that both the throttle lever L₁ and the clutch lever L₂ are maximally close to the handle H;

FIG. 7 is a side view of the portion of the handle H in a condition that both the throttle lever L₁ and the clutch lever L₂ are released from the handle H;

FIG. 8 is an X arrow view of FIG. 6;

FIG. 9 is a perspective view of the portion of the handle H in a condition that both the throttle lever L₁ and the clutch lever L₂ are released from the handle H; and

FIG. 10 is a perspective view of the portion of the handle H in a condition that both the throttle lever L₁ and the clutch lever L₂ are maximally close to the handle H.

### DESCRIPTION OF THE PREFERRED EMBODIMENT

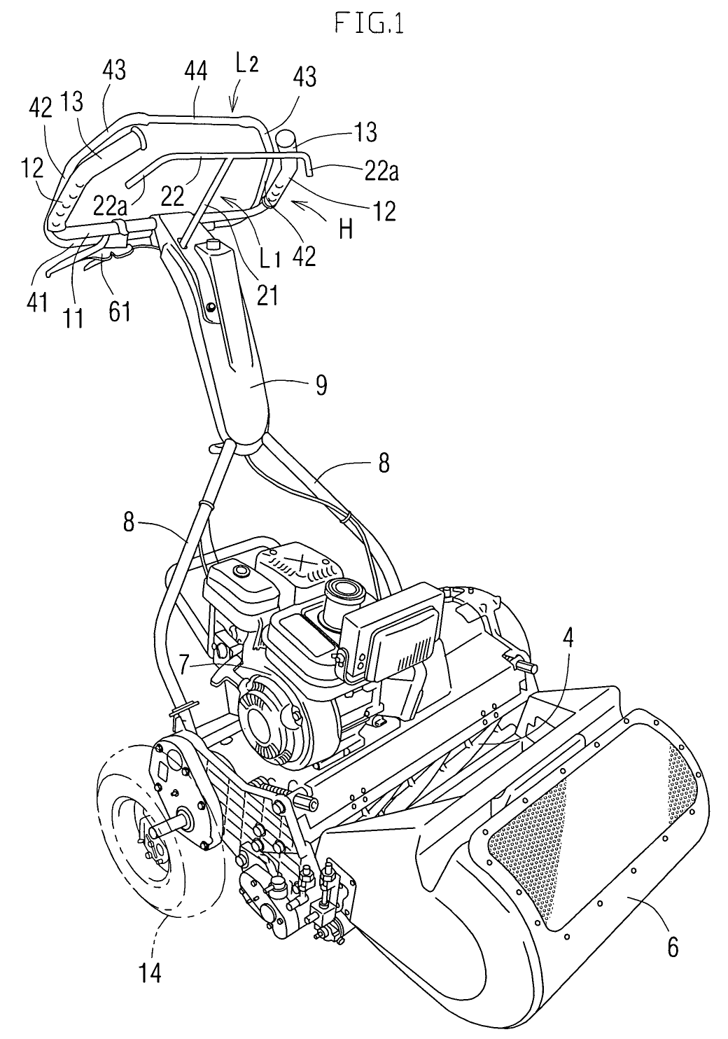

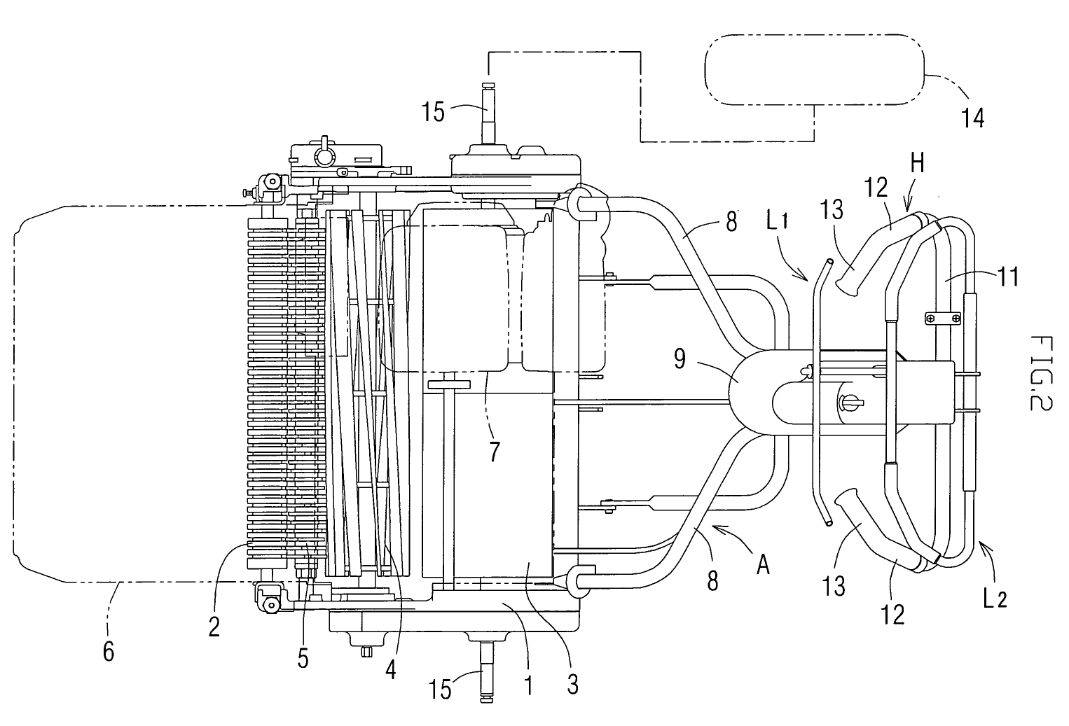

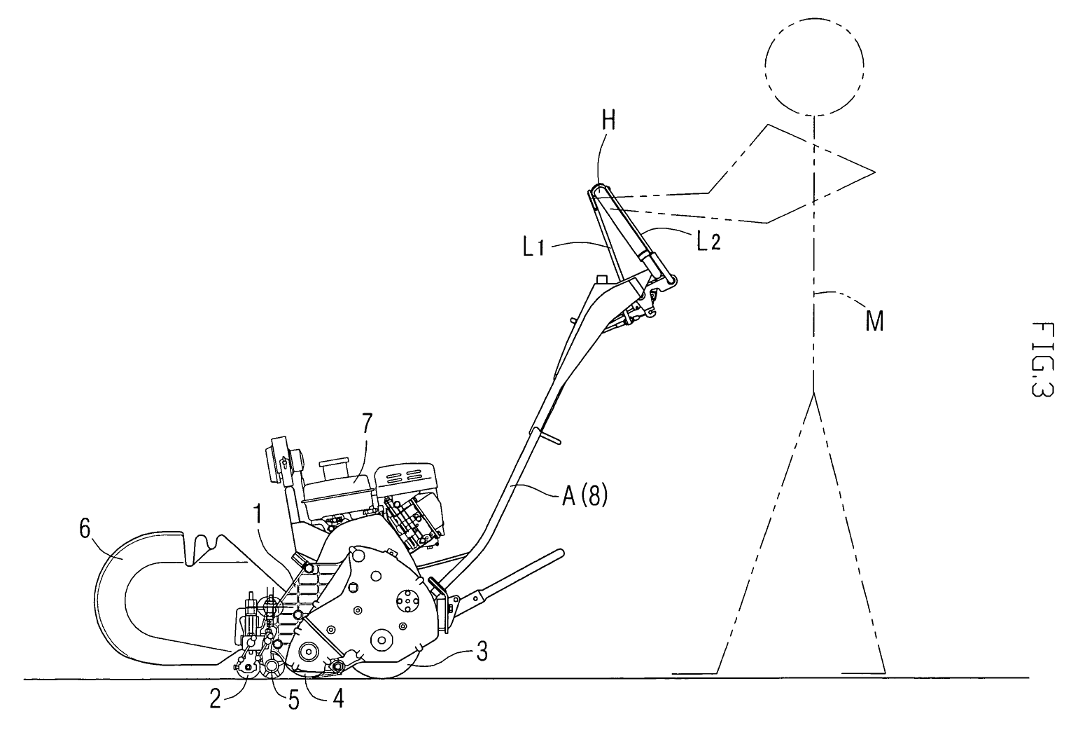

First, an outline of a walk-behind lawn mower is described with reference to FIGS. 1 to 3, and then a drive operation device according to an embodiment of the invention is described. FIG. 1 is an overall perspective view of a walk-behind lawn mower according to an embodiment of the invention; FIG. 2 is a plane view of the lawn mower in a condition that a grass catcher 6 is removed; and FIG. 3 is a side view of the lawn mower in a condition of lawn mowing. In the lawn mower, a front roller 2 and a drum 3 are mounted with a predetermined interval in the front and the rear of a machine 1 respectively, a reel cutter 4 is arranged between the front roller 2 and the drum 3, and a thatching roller 5 for raking dried grass and the like biting in lawn before mowing is arranged between the reel cutter 4 and the front roller 2. Mowing height of lawn is determined by controlling height of the front roller 2 with respect to the machine 1. The grass catcher 6 for gathering and accommodating lawn mowed by the reel cutter 4 is mounted in the front of the machine 1 in a forward protruded manner. An engine 7 for driving the drum 3 and the reel cutter 4 is mounted on a top of the machine 1.

In a rear of the machine 1, a handle arm A is integrally attached toward an obliquely upper back. The handle arm A is formed by bending two rods 8, wherein approximately half the base end sides of respective rods 8 are attached to the machine 1 in a furcate shape, and approximately half the front end sides of respective rods 8 are formed in a manner that the respective rods 8 are bound in one, and a bound portion of the rods 8 is covered with a handle cover 9. A loop handle H is integrally attached to an obliquely upper end (obliquely upper back end with the machine 1 as a reference) of the handle arm A in a slightly forward-bent manner. The handle H includes a horizontal fixing portion 11 integrally fixed to the obliquely upper end of the handle arm A with being disposed along a lateral direction of the machine 1; a horizontal pair of first grasp portions 12 being oppositely disposed at both ends of the horizontal fixing portion 11 while standing from the horizontal fixing portion 11 by being inwardly bent at angle of more than 90 degrees; and a horizontal pair of second grasp portions 13 being oppositely disposed by further inwardly bending front ends of the first grasp portions 12 by about 30 degrees. The first and second grasp portions 12 and 13 are in a short straight line shape respectively. Therefore, a space is formed between the horizontal pair of second grasp portions 13.

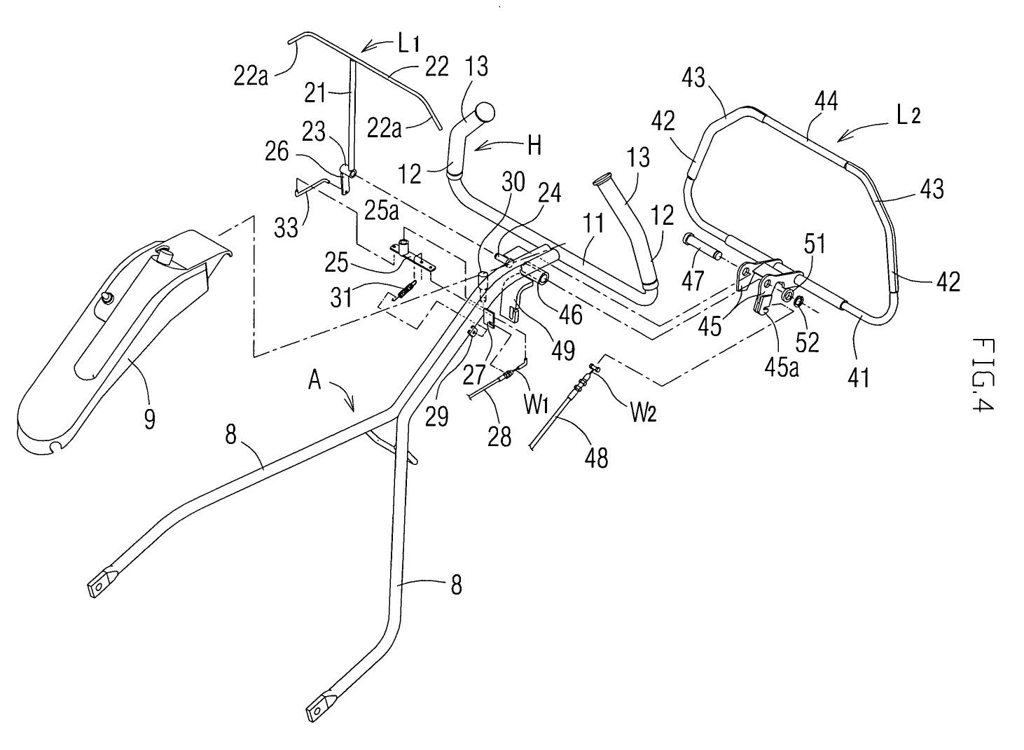

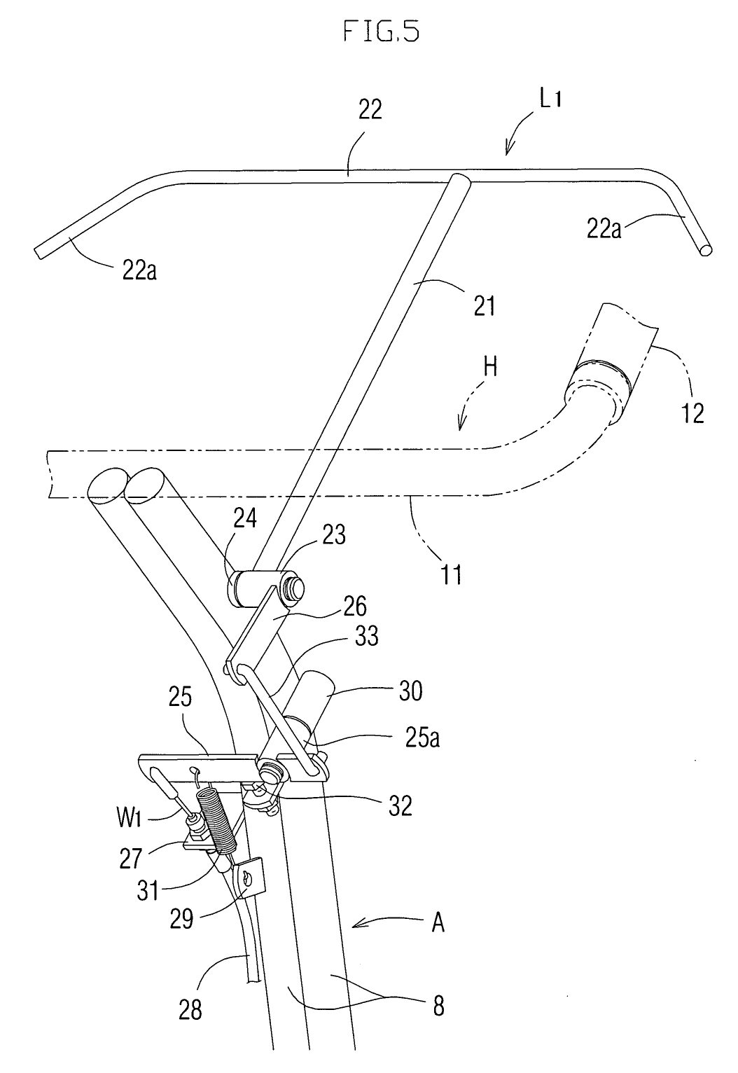

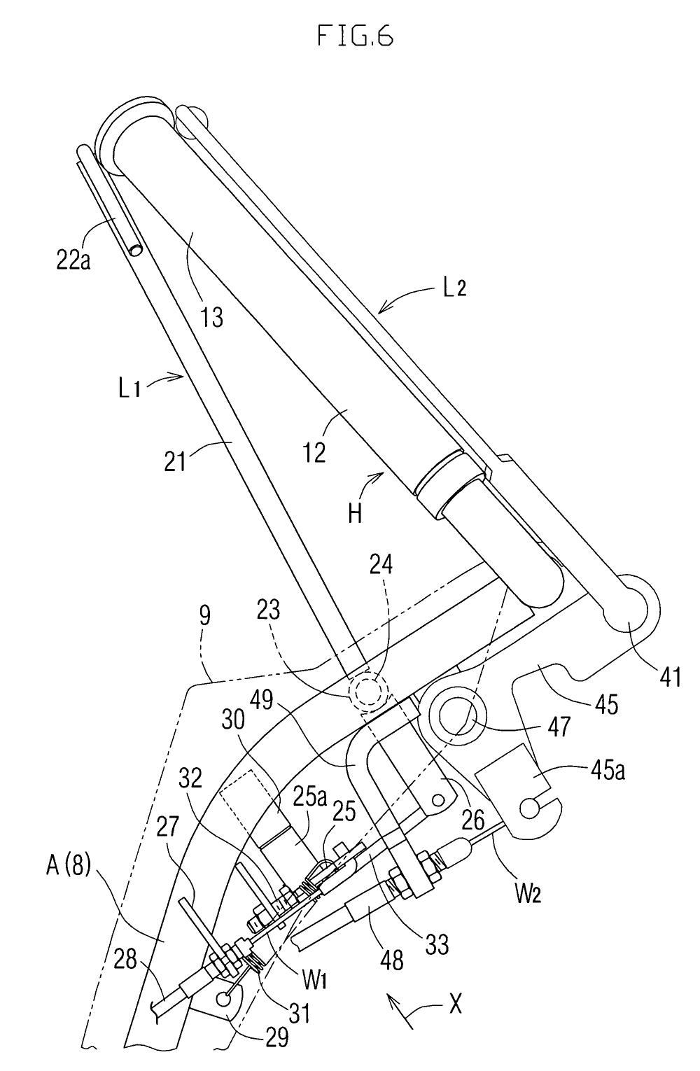

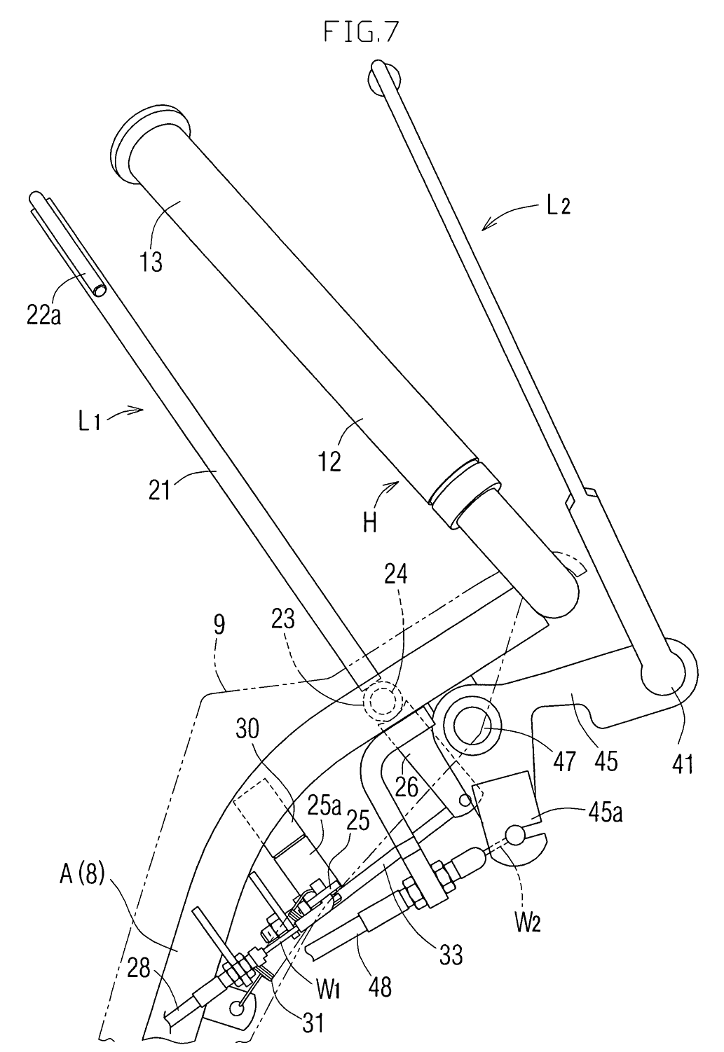

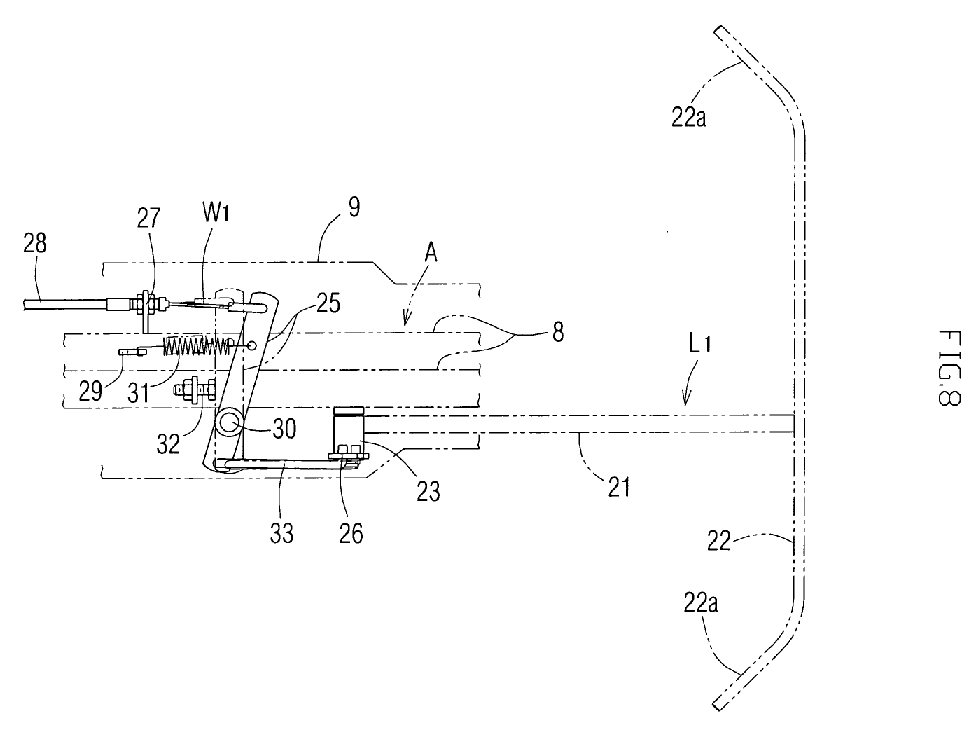

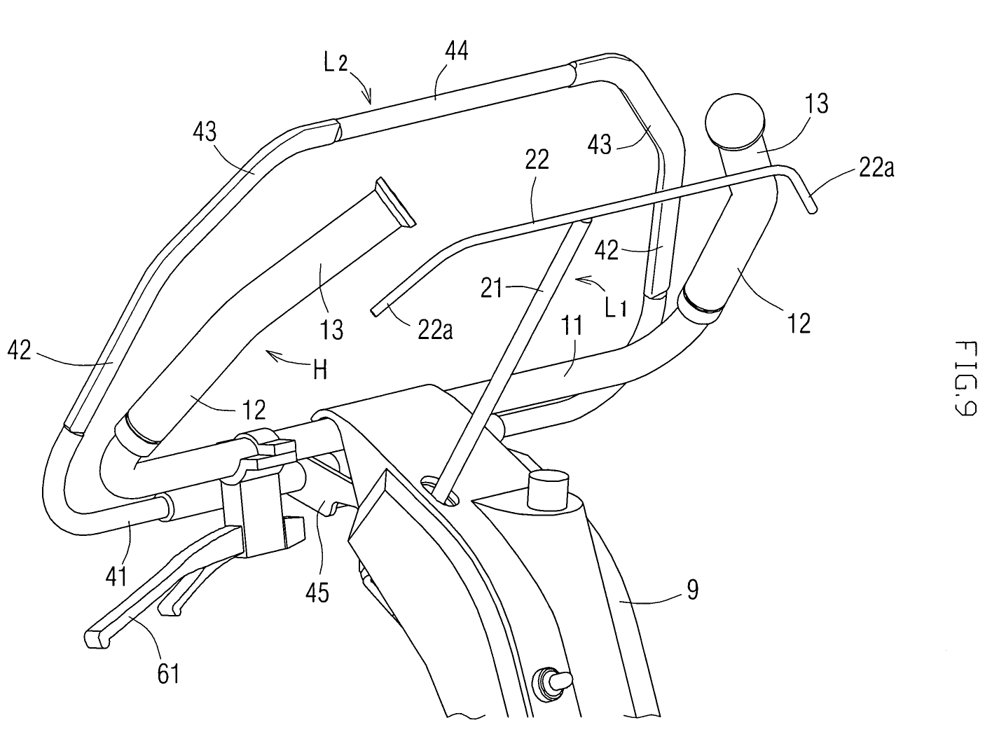

Next, a section of the drive operation device according to an embodiment of the invention is described with reference to FIGS. 4 to 8. FIG. 4 is an exploded perspective view of the handle H, a throttle lever L₁, and a clutch lever L₂, which are fixed to the handle arm A; FIG. 5 is a perspective view, which is seen from a lower side, of only a portion of the throttle lever L₁ attached to the handle arm A; FIG. 6 is a side view of a portion of the handle H in a condition that both the throttle lever L₁ and the clutch lever L₂ are maximally close to the handle H; FIG. 7 is a side view of the portion of the handle H in a condition that both the throttle lever L₁ and the clutch lever L₂ are released from the handle H; FIG. 8 is an X arrow view of FIG. 6; and FIG. 9 is a perspective view of the portion of the handle H in the condition that both the throttle lever L₁ and the clutch lever L₂ are released from the handle H.

In the throttle lever L₁, a horizontal rod 22 is provided in the lateral direction of the machine 1 at an upper end of a rotation support rod 21 rotatably supported with respect to the handle arm A so that the throttle lever is in an approximately T-shape, and a rotation support cylinder 23 integrally provided at a base end of the rotation support rod 21 is rotatably supported by a throttle lever fulcrum shaft 24 horizontally protruded to a side of the obliquely upper end of the handle arm A, thereby the throttle lever is disposed in an obliquely lower front of the handle H near the handle H. Accordingly, the throttle lever L₁ in the approximately T-shape is rotated about the fulcrum shaft 24 such that it approach the handle H, or is separated from the handle H. Both ends of the horizontal rod portion 22 of the throttle lever L₁ are approximately parallel to the second grasp portions 13 of the handle H in a condition that the throttle lever L₁ is maximally drawn to a side of the handle H, in addition, the ends are bent to an obliquely lower side such that they are disposed with being partially overlapped with the second grasp portions along a lateral direction, thereby both the ends are formed as drawing portions 22a.

On the other hand, in a slightly front of the fulcrum shaft 24 on the handle arm A, a horizontal lever fulcrum shaft 30 is integrally provided approximately vertically, and a fulcrum cylinder 25a of a horizontal lever 25 is rotatably supported by a small diameter portion of a lower half of the horizontal lever fulcrum shaft 30. One end of the horizontal lever 25 is connected to a lever portion 26, which extends to an opposite side via the rotation support cylinder 23 from a lower end of the rotation support rod 21 of the throttle lever L₁ via a link 33, and the other end of the horizontal lever 25 is connected to one end of a throttle wire W₁. At a side opposite to a side of the throttle lever fulcrum shaft 24 and the horizontal lever fulcrum shaft 30 on the handle arm A, a tube bracket 27 is attached, and one end of a wire tube 28 inserted with the throttle wire W₁ is fixed to the bracket 27. A tension spring 31 having one end connected to the spring bracket 29 is connected between the fulcrum cylinder 25a and a connection portion with the throttle wire W₁ of the horizontal lever 25. Accordingly, the throttle lever L₁ is rotatably supported such that it is rotated back and forth with respect to the handle H about the throttle lever fulcrum shaft 24 while the throttle lever is biased in a direction to be separated from the handle H by drawing force of the throttle wire W₁ and the tension spring 31. Here, since biasing force is insufficient when only the drawing force of the throttle wire W₁ biases the throttle lever L₁ in a direction to be separated from the handle H, it is configured that the one end of the tension spring 31 is connected between the fulcrum cylinder 25a and the connection portion with the throttle wire W₁ of the horizontal lever 25, and the biasing force is increased by tension of tension spring 31, so that the throttle lever L₁ is securely separated to a maximally separated position by being released from the handle H. The maximally separated position of the throttle lever L₁ is defined based on a condition that fingertips of hands grasping the second grasp portions 13 of the handle H reach to the drawing sections 22a even in the maximally separated position. The spring bracket 29 is fixed to a bottom (back) of the handle arm A. In FIGS. 4, 5 and 7, a numeral 32 shows a stopper for restricting a return position of the horizontal lever 25 returned by the tension spring 31.

Accordingly, when the throttle lever L₁ is drawn to a side maximally close to the handle H, the horizontal lever 25 is rotated counterclockwise in a plane view against the drawing force of the throttle wire W₁ and tensile strength of the tension spring 31, so that the throttle wire W₁ is maximally drawn out from the wire tube 28, thereby rotation frequency of the engine 7 is maximized. When the throttle lever L₁ is released from the handle H, the horizontal lever 25 is forcibly rotated clockwise in a plane view by the drawing force of the throttle wire W₁ and the tension of the tension spring 31, thereby the throttle lever L₁ is rotated to a position maximally separated from the handle H, consequently rotation frequency of the engine 7 is minimized to be a rotation frequency at which the machine 1 cannot travel in most cases. Since the fulcrum cylinder 25a being a rotation fulcrum of the horizontal lever 25 is significantly unevenly distributed to a side of the connection portion with the link 33 with respect to the longitudinal center of the horizontal lever 25, maximum drawing length of the throttle wire W₁ from the wire tube 28 is extremely longer than moving length of a connection portion between the lever portion 26 and the link 33, the connection portion being provided at a side lower than the rotation support cylinder 23 of the throttle lever L₁.

In the embodiment, the drawing portions 22a being both ends of the horizontal rod 22 of the throttle lever L₁ reach to regions of the second grasp portions 13 of the handle H, but does not reach to regions of the first grasp portions 12. This is because a fact that most of operators often drive a lawn mower while grasping the second grasp portions 13 rather than the first grasp portions 12 due to a driving posture. However, the drawing portions 22a of the throttle lever L₁ can be formed conformably to both the first and second grasp portions 12, 13 of the handle H so that they can be drawn to either of the grasp portions 12, 13.

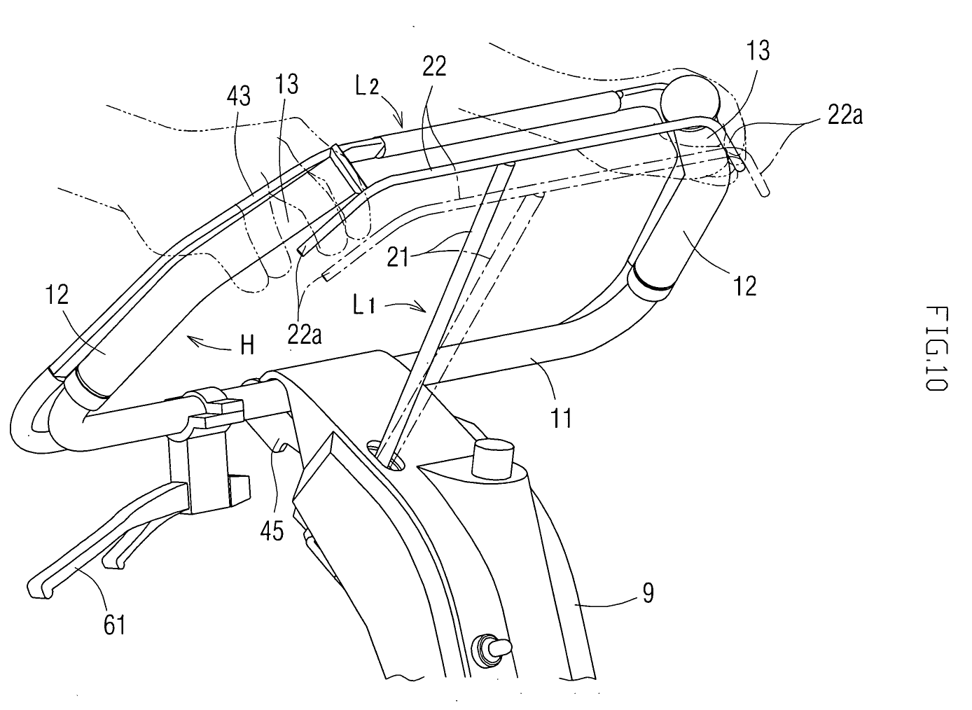

The clutch lever L₂ is in such a shape that the handle H is made in a perfect loop shape to improve stiffness, that is, in a shape where the horizontal pair of second grasp portions 13 being oppositely disposed are connected by a straight line portion, and disposed behind and near the handle H. The clutch lever L₂ is in a configuration where both sides of a horizontal base end 41 are inwardly bent at an angle of more than 90 degrees so that a pair of first grasp portions 42 are formed in an oppositely disposed manner, and upper ends of the respective first grasp portions 42 are further inwardly bent so that a pair of second grasp portions 43 are formed in an oppositely disposed manner, and the respective second grasp portions 43 being oppositely disposed are connected to each other by a horizontal connection portion 44. The clutch lever L₂ is rotatably supported by the handle arm A via a pair of lever bodies 45 integrally fixed to the horizontal base end 41. That is, a fulcrum cylinder 46 is fixed along the lateral direction of the machine 1 in a portion near an obliquely upper end on a back of the handle arm A; the pair of lever bodies 45 attached to the horizontal base end 41 of the clutch lever L₂ is rotatably supported by the fulcrum cylinder 46 via a fulcrum pin 47; and one end of a clutch wire W₂ is connected to a downward extending portion 45a of one of the lever bodies 45. One end of a wire tube 48 is fixed to a tube bracket 49 fixed to the back of the handle arm A, and the wire tube 48 is inserted with the clutch wire W₂. Since the clutch wire W₂ is biased in a direction to be drawn into the wire tube 48 (clutch disengaging direction), and one of the lever bodies 45 is contacted to a (shown) stopper fixed to the back of the handle arm A, the clutch lever L₂ is separated from the handle H so that the clutch is disengaged in a condition that the clutch is not operated. In FIG. 4, numerals 51 and 52 show a spacer and an E ring to be fitted on an end of a fulcrum pin 47 respectively. In FIG. 1, FIG. 9 and FIG. 10, numeral 61 shows a brake lever attached to the horizontal fixing portion 11 of the handle H.

Next, a drive operation method of the lawn mower is described with reference to FIG. 3, and FIGS. 6 to 10. FIG. 10 is a perspective view of the portion of the handle H in a condition that both the throttle lever L₁ and the clutch lever L₂ are made maximally close to the handle H. In a condition shown by two-dot chain lines in FIG. 7 and FIG. 8, or a condition shown in FIG. 9, the throttle lever L₁ and the clutch lever L₂ are maximally separated from the handle H, which corresponds to a condition that the lawn mower is stopped. That is, the horizontal lever 25 is biased clockwise in a plane view by the drawing force of the throttle wire W₁ and the tension of the tension spring 31, and contacted to a stopper 32, so that the throttle lever L₁ is maximally separated from the handle H, and the throttle wire W₁ is maximally drawn into the wire tube 28, thereby rotation frequency of the engine 7 is minimized. The clutch wire W₂ is maximally drawn into the wire tube 48 by drawing force of itself, and the clutch lever L₂ is rotated in a direction to be separated from the handle H about the fulcrum pin 47 by the relevant drawing force, and separated to a maximally separated position.

In the stop condition of the lawn mower, as shown in FIG. 3 and FIG. 10, in a back of the machine 1, an operator M grasps the clutch lever L₂ to a side of the handle H by hands (both hands in many cases) grasping the second grasp portions 13 of the handle H, and draws one or both of the pair of the drawing portions 22a of the throttle lever L₁ to the side of the handle H by a predetermined amount by fingertips of a hand grasping both the handle H and the clutch lever L₂. That is, when three components of the handle H, throttle lever L₁, and clutch lever L₂ are grasped together so that the throttle lever L₁ and clutch lever L₂ are allowed to approach the side of the handle H or contact to the handle H, the engine 7 is rotated at a rotation frequency corresponding to the drawing amount of the throttle lever L₁, thereby the machine 1 starts travelling for lawn mowing. That is, power of the engine 7 is transmitted to both the drum 3 and the reel cutter 4, and the machine 1 travels by being driven by rotation of the drum 3, and lawn is mowed at a setting height by rotation of the reel cutter 4.

When travel speed of the machine 1 is changed during lawn mowing, while the handle H and the clutch lever L₂ are grasped by a hand, the drawing amount of the throttle lever L₁ being drawn to the handle H side can be controlled by fingertips of the relevant hand. That is, when the throttle lever L₁ is further drawn to the handle H side, the rotation frequency of the engine 7 is increased and thus travel speed of the machine 1 is increased. In addition, when the fingertips drawing the drawing portions 22a of the throttle lever L₁ are made in a slightly released condition, the amount of separation of the throttle lever L₁ from the handle H is increased due to the drawing force of the throttle wire W₁ and the tension of the tension spring 31, thereby the rotation frequency of the engine 7 is decreased, as a result, travel speed of the machine 1 is decreased.

In the case that the lawn mower is desired to be suddenly stopped during lawn mowing, when both of drawing of the throttle lever L₁ and grasp of the clutch lever L₂ by the hand grasping the handle H are released at the same time, the throttle lever L₁ is separated to the maximally separable position from the handle H by the drawing force of the throttle wire W₁ and the tension of the tension spring 31, thereby the rotation frequency of the engine 7 is minimized, and the clutch lever L₂ is separated to the maximally separable position by drawing force of the clutch wire W₂, thereby a clutch (not shown) is disengaged, and power of the engine 7 is not transmitted to both the drum 3 and the reel cutter 4. As a result, when both of the drawing of the throttle lever L₁ and the grasp of the clutch lever L₂ are released, the machine 1 is stopped at the same time.

On the other hand, when the machine 1 is turned, while the handle H is lowered with the drum 3 as a center to raise a reel cutter 4 side in a condition that the handle H, throttle lever L₁, and clutch lever L₂ are grasped by using only a hand in an inner side of a turn, and a hand in an outside of the turn is released from the handle H, in addition, as necessary, while the drawing amount of the throttle lever L₁ is appropriately controlled by one of the hands grasping the handle H, that is, while controlling turn speed, the machine 1 can be turned. Accordingly, turning operation of the machine 1 is facilitated, and turn speed can be controlled in the same drive posture except for difference in horizontal direction without releasing hands from the handle H during a turn in a case of a turn to either of right and left sides. In FIG. 1 and FIG. 2, numeral 14 shows a wheel removably equipped on the drum shaft 15.

Regarding the loop handle, the invention can be carried out not only to the lawn mower having a handle of an imperfect loop type such as the handle H of the embodiment, but also to a lawn mower having a handle of a perfect loop type. In the case of the handle of the perfect loop type, the drawing portion of the throttle lever is made in a shape conformable to all regions of the grasp portions of the handle, thereby the throttle lever can be operated in the case that any region of the grasp portions of the handle is grasped.

Since the throttle lever L₁ is biased in a direction to be separated from the handle H by the drawing force of the throttle wire W₁ and the tension of the tension spring 31 in the embodiment, an operator needs to continuously draw the throttle lever L₁ to the handle H side by a hand grasping the handle during travelling of the machine 1. However, it can be configured that a “resistance section” is previously formed in a mechanism for converting approximate straight-line movement of a tip connection portion of the lever portion 26 of the throttle lever L₁ into each movement of extraction and retraction of the throttle wire W₁, and a drawing position of the throttle lever can be fixed by the “resistance section”, and an operator operates the throttle lever only in the case that engine rotation frequency is changed.

While the embodiment is configured such that the hand grasping the handle can operate not only the throttle lever, but also the clutch lever, the invention can be similarly carried out to a lawn mower in which the clutch lever is operated with hands being released from the handle. In the case of such a configuration, the throttle lever can be arranged in either of the front and the rear of the handle.

1. A drive operation device of a walk-behind lawn mower in a form that a handle arm is integrally provided toward an obliquely upper back in a rear of a machine, and a loop handle is provided at a rear end of the relevant handle arm with slightly tilting forward, and an operator performs drive operation while walking following the machine that travels by itself at a back of the machine, comprising:
a throttle lever, the throttle lever being able to be drawn together with the handle by being operated by either of right and left hands grasping the handle, in addition, engine rotation frequency being able to be controlled using the amount of drawing,
wherein the throttle lever is rotatably provided on the handle arm in an obliquely lower front or an obliquely upper back of the handle.

2. The drive operation device of the walk-behind lawn mower according to claim 1:
wherein the throttle lever is provided in an obliquely lower front of the handle, and a clutch lever, which can be grasped together with the handle by either of right and left hands grasping the handle, is rotatably provided in an obliquely upper back of the handle, and
three components of the handle, clutch lever, and throttle lever are grasped together for operation.

3. The drive operation device of the walk-behind lawn mower according to claim 2:
wherein the handle is in a shape in which both ends of a horizontal fixing portion fixed to the handle arm is inwardly bent at an angle of more than 90 degrees, thereby a horizontal pair of grasp portions being oppositely disposed are formed in a standing manner, and
the throttle lever is in an approximately T-shape, in which a horizontal rod portion is provided along a lateral direction of the machine in upper ends of rotation support rods rotatably supported in a condition standing from the handle arm, and
both ends of the horizontal rods of the throttle lever are bent to an oblique lower side such that they are approximately parallel to the grasp portions in a condition of being disposed in an overlapped manner with the grasp portions along the lateral direction of the machine so that they are easily grasped by the hands grasping the grasp portions of the handle, thereby both the ends are formed as drawing portions.

4. The drive operation device of the walk-behind lawn mower according to claim 1:
wherein the drive operation device is configured such that the throttle lever is rotationally biased in a direction to be separated from the handle, and the throttle lever is drawn to a handle side to be close to the handle, thereby engine rotation frequency is increased, and the engine rotation frequency is minimized by releasing the throttle lever.

5. The drive operation device of the walk-behind lawn mower according to claim 2:
wherein the drive operation device is configured such that the throttle lever is rotationally biased in a direction to be separated from the handle, and the throttle lever is drawn to a handle side to be close to the handle, thereby engine rotation frequency is increased, and the engine rotation frequency is minimized by releasing the throttle lever.

6. The drive operation device of the walk-behind lawn mower according to claim 3:
wherein the drive operation device is configured such that the throttle lever is rotationally biased in a direction to be separated from the handle, and the throttle lever is drawn to a handle side to be close to the handle, thereby engine rotation frequency is increased, and the engine rotation frequency is minimized by releasing the throttle lever.
